(19) United States
(12) Patent Application Publication
(10) Pub. No.: US 2013/0096768 A1
(43) Pub. Date: Apr. 18, 2013

(54) Method and Apparatus for Do Not Disturb Message Delivery

(71) Applicants: Karin Lovett, Novi, MI (US); Jason C. Marcath, Dearborn, MI (US); Thanh Duc Pham, Canton, MI (US); Beth Ann Dalrymple, Livonia, MI (US); Jesus Cardoso, Allen Park, MI (US); David Hayes, Northville, MI (US); Hsiao-An Hsieh, Troy, MI (US); Darko Acevski, Sterling Heights, MI (US)

(72) Inventors: Karin Lovett, Novi, MI (US); Jason C. Marcath, Dearborn, MI (US); Thanh Duc Pham, Canton, MI (US); Beth Ann Dalrymple, Livonia, MI (US); Jesus Cardoso, Allen Park, MI (US); David Hayes, Northville, MI (US); Hsiao-An Hsieh, Troy, MI (US); Darko Acevski, Sterling Heights, MI (US)

(73) Assignee: FORD GLOBAL TECHNOLOGIES, LLC, Dearborn, MI (US)

(21) Appl. No.: 13/272,357

(22) Filed: Oct. 13, 2011

(51) Int. Cl. G06F 19/00; G01M 17/00

(52) U.S. Cl. 701/29.1

(57) ABSTRACT

A computer-implemented method includes detecting a reportable change in vehicle state. The method also includes qualifying the reportable change for delivery based on evaluation of one or more situational variables associated with the reportable change. Further, the method includes delivering a notification relating to the reportable change to a wireless to be delivered to a device user despite an active do not disturb state of the wireless device, conditional on the qualification of the reportable change as deliverable.

### TECHNICAL FIELD

The illustrative embodiments generally relate to a method and apparatus for do not disturb message delivery.

### BACKGROUND

The integration of computing systems into vehicles has provided modern vehicles that are ever increasing in “smart” capability. Progammable vehicle systems provide a customizable vehicle environment, and on-board technology can easily provide a driver with navigation, entertainment and fuel optimization options.

Additionally, cellular phone integration and compatibility has lead to the opportunity for drivers to receive calls in a vehicle. These calls can be handled by a vehicle system, and are often done so in a hands free manner. Of course, since drivers do not always want to be disturbed during a drive, it may be possible to set a do not disturb feature that blocks calls when enabled, or when certain conditions are met.

In addition to integrating with phone technology while the driver is in a vehicle, a secondary concept of phone integration has also arisen. Since vehicle computing systems can have an embedded phone or other transmission device included therewith (e.g., without limitation, WiFi, ZigBee, etc.), it may be possible for a vehicle to actually contact a cellular phone, computer, etc. while the driver is away from the vehicle.

The ability for a vehicle to contact an owner has numerous applications. On a hot day, an owner can be notified if a vehicle interior temperature rises above a certain point, and remote HVAC may be enabled to cool the vehicle. Drivers can also be notified if an attempt is made to breach the security of a vehicle, or, for example, if a vehicle is being moved/towed.

Numerous alerts are possible in a vehicle-to-phone environment, and can be provided such that a driver is kept up to date on a state of the vehicle while the driver is away. Of course, just as a driver does not always want to be disturbed while driving, a driver similarly may not want an alert that the vehicle has risen above a certain temperature if the driver is in an important business meeting.

### SUMMARY

In a first illustrative example, a computer-implemented method includes detecting a reportable change in vehicle state. The method also includes qualifying the reportable change for delivery based on evaluation of one or more situational variables associated with the reportable change. Further, the method includes delivering a notification relating to the reportable change to a wireless to be delivered to a device user despite an active do not disturb state of the wireless device, conditional on the qualification of the reportable change as deliverable.

In a second illustrative example, a computer readable storage medium stores instructions that, when executed, cause a processor of a computing system to execute the method including detecting a reportable change in vehicle state. The executed method also includes evaluating one or more situational variables associated with the reportable change to determine a criticality level of the reportable change. Also, the method includes comparing the criticality level of the reportable change to a filter associated with an active do not disturb state to qualify the reportable change for delivery. The method further includes delivering a notification relating to the reportable change despite the active do not disturb state, conditional on the qualification of the reportable change as deliverable.

In a third illustrative embodiment, a computer implemented method includes monitoring a log of alerts having been logged due to non-delivery to a user resulting at least in part from a do not disturb state of a wireless device. The method also includes selecting at least one logged alert having one or more situational variables associated therewith for evaluation. Also, the method includes evaluating the one or more situational variables to determine if a change in a deliverable nature of the logged alert has occurred. The method additionally includes delivering a notification to a wireless device relating to the logged alert, for delivery to a device user despite an active do not disturb state of the wireless device, contingent on a change in the deliverable nature of the logged alert to a deliverable status.

### BRIEF DESCRIPTION OF THE DRAWINGS

FIG. 1 shows an illustrative vehicle computing system;

FIG. 2 shows an illustrative configuration process;

FIG. 3 shows an illustrative event queuing process;

FIG. 4 shows a second illustrative event queuing process;

FIG. 5 shows an illustrative example of an alert customization process;

FIG. 6 shows an illustrative example of an alert handling process;

FIG. 7 shows another illustrative example of an alert handling process; and

FIG. 8 shows an illustrative example of an alert log handling process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

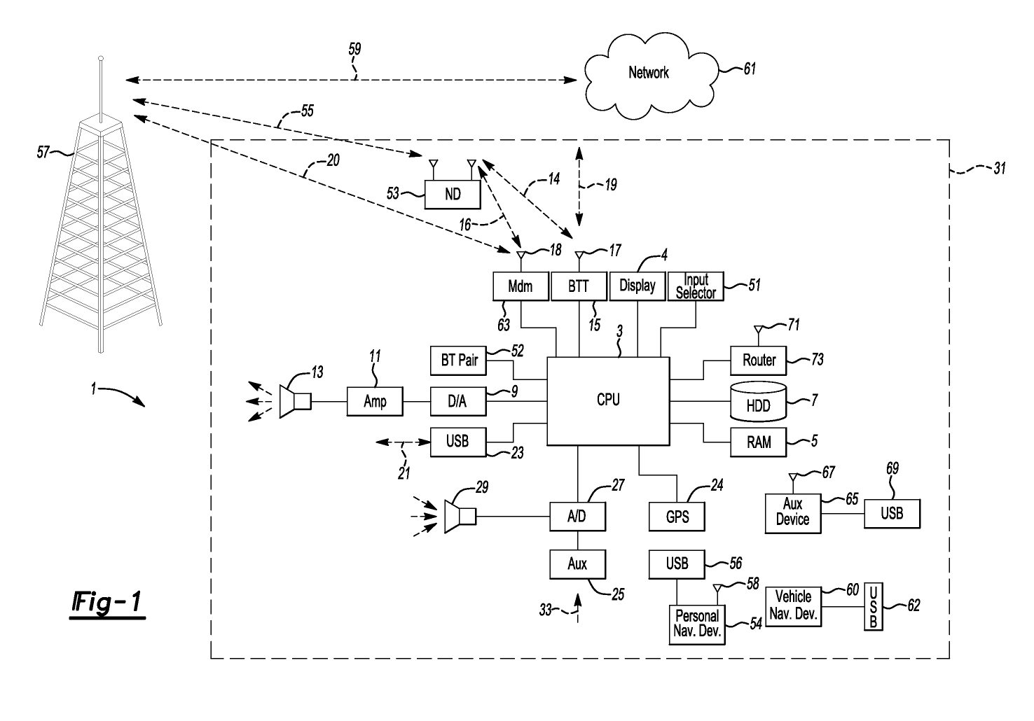

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Recent studies have shown that a large point of concern with hybrid, plug-in and battery electric vehicles (HEVs, PHEVs, and BEVs) is the range and charge state of the vehicle. This can largely be attributed to the charging times associated with fully charging a vehicle. Unlike gasoline powered vehicles, which can be refueled in a matter of minutes, electric vehicles (EVs) can take a significantly longer time to recharge.

Typically, this does not present a problem for an average commuter, as the vehicle can be charged overnight, and then driven as needed the following day. As long as the user remembers to charge the vehicle, there should be no problem obtaining sufficient charge for activities on a day to day basis.

Sometimes, however, the user may forget to plug in the vehicle, or, for example, the vehicle may become unplugged. In other cases, the user may wish to know when a vehicle is fully charged, so that a plug can be removed or used for a second vehicle. Accordingly, with the integration of communication devices into vehicle computing systems, it has become possible for a vehicle to actively notify an owner when a condition relating to charge, for example, has been met.

Since vehicle computing systems can be provided with a limited “intelligence,” it could be possible, for example, for a vehicle to “realize” that an owner typically uses a vehicle between six and seven A.M. on a weekday. If, at some point reasonably before this time, the vehicle detects that it has not been plugged in and/or does not have a threshold level of charge, a user may be notified that the charging event has not occurred. One way to notify a user is to send a message to the user's cellular phone.

In another example, a user may wish only to charge a vehicle to a certain point (to save on electricity costs, for example). In this case, the vehicle may notify a user when a certain charge has been reached. The user could then unplug the vehicle, leave the vehicle plugged in, or even send instructions to a vehicle to cease charging.

In still a further example, a user may wish to know when a vehicle is fully charged. Since it could be a nuisance to have to periodically go out to the vehicle and check a charge state, the vehicle could be configured to inform a user when a full charge state has been reached. Multiple other events related to charging and other vehicle states are also contemplated within the scope of this invention.

Although it is generally convenient to have the capability for a vehicle to notify a user when a charging condition has been met, there are certainly times when a user may not wish to be disturbed. For example, a user may not wish to be woken up at 2 AM to be notified that a vehicle is fully charged. Accordingly, it is possible for a user to enable a do not disturb feature on the vehicle computer, on a cellular application, or on a remote network through which a notification may pass.

Unfortunately, if a notification system is not selectively enabled (i.e., if all notifications are blocked), a user may miss an important event. For example, if a user really needs a night's sleep, or is in an important meeting, an election may be made to block all notifications for a selective time period. While it may not be critical to the user to be notified that a vehicle is fully charged, if, for example, a vehicle was unplugged, or a power outage occurred and the vehicle was not charging, the user may return to the vehicle unaware that charging had been interrupted and discover that insufficient charge remains in the vehicle to provide for a desired travel distance.

To address this potential situation, the illustrative embodiments contemplate a solution that enables queuing and delivery of events occurring during a do not disturb period, once that period has ended.

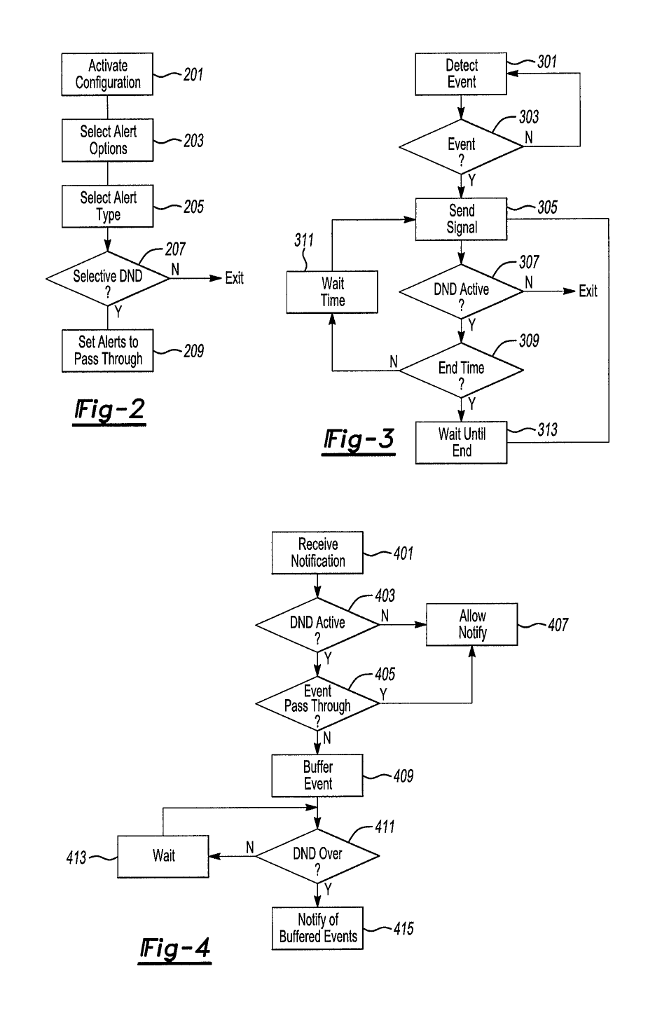

FIG. 2 shows an illustrative configuration process. This process allows a user to select what events will result in notification to a user's device. Since there could literally be hundreds of events of which a particular user could be notified, it may be desirable to allow some selectivity in the process.

In this example, a configuration protocol is activated. This configuration can occur, for example, on a cellular phone, on a vehicle computing system, or on a remote site that controls event notification.

In one example, the process occurs on an application provided to a wireless device. The application can act as a gatekeeper for notification, and can provide a comprehensive listing of all possible notification events. The user can elect events for which notification is desired, and the application can save a listing of the elected events.

In one embodiment, a vehicle system can send all events to the wireless device, and the active application can filter the presented events down to those which the user has elected. Certain events may also be deemed “critical,” and can override the notification selection and always be presented to the user.

In another embodiment, the application can serve as a configuration utility as opposed to a gatekeeper, and, once event configuration has been elected, the device can transfer the settings to a vehicle computing system.

In another example, the user can directly interface with a vehicle computing system to select notification events. Again, in this example, the vehicle computing system can serve as the gatekeeper and the selection of events can result in a general block/pass-through configuration that only allows selective event delivery.

Similar to the situation with the wireless device acting as a configuration utility, the vehicle system can pass a configuration to a wireless device application once set, if the wireless device is to act as the gatekeeper. Additionally or alternatively, either medium can be used to set events (or receive settings from) a remote source, if events pass through a controllable server before arriving at a wireless device.

In remote server alternative, the server can provide a configuration and/or gatekeeper functionality as well, and may be configurable from, for example a website. In at least one embodiment, a user may use a website to configure notification, and then, when entering and powering the vehicle, the data from the website may be distributed to the wireless device and/or the vehicle computing system (in communication with the server through the wireless device). In this manner, configuration and/or gatekeeping functionality may be determined at any one of numerous points and/or transferred to other points in a system as necessary.

In the configuration process shown in FIG. 2, a configuration utility is launched by a user 201. A configuration utility may be useful in an instance where event notification is not preset by a manufacturer and is non-user configurable.

The user is then given an option to select alert options 205. Selection of options can include, but is not limited to, selection of option type (e.g., text, email, phone call, etc.), selection of type of do not disturb (full block, critical alert passthrough, selective do not disturb, etc.), etc.

If, for example, selection of do not disturb configuration is chosen, the user may set times or conditions for do not disturb enablement. Additionally or alternatively, the user can enable “full” do not disturb at certain times, and selective do not disturb at other times.

In this example, a user is given the option to select particular alerts 205. Since a myriad of alerts may be available for selection, a user may wish to configure and select only a subset of these alerts. In another example, a user may configure which alerts have priority as pass-through alerts, such that critical alerts ignore a do not disturb feature.

If selective do not disturb has been enabled for at least some period of time 207, the user may additionally be given an option to call out chosen alerts for passthrough 209. For example, if a user elected to be notified of an unplugged event, a fully charged event and a security-breach event, the user may then decide to always be notified of a security breach, to sometimes be notified of an unplugged event (but not, perhaps, at 2 AM), and to only be notified of a fully charged event if do not disturbed is disengaged.

FIG. 3 shows an illustrative event queuing process. Since certain events may be blocked during do not disturb periods, it may be desirable to notify a user of these events once a do not disturb period is over. In this example, the wireless device acts as the do not disturb gatekeeper, and the vehicle computing system acts as the queuing and notification delivery system. Various illustrative embodiments will be described herein where different systems perform varying roles, but it is understood that most, if not all, of these roles are interchangeable and such interchangeability is contemplated within the scope of the invention.

In this example, the vehicle computing system (VCS) detects the occurrence of an event 301. In one case, the event may be any event available for notification, in another example the event may correspond to one or more events selected for notification (i.e., the system will ignore non-selected events).

In this illustrative embodiment, for the sake of example, it is assumed that the event corresponds to any event available for notification. If the event also qualifies as a selected event 303, the VCS will send a notification signal to a wireless device designated for notification 305. Additionally or alternatively, the notification signal can be sent to a remote server designated to notify a wireless device or other notification medium.

If do not disturb (DND) is not active 307, the message will be delivered as sent, and the vehicle owner will receive the sent notice. If, however, do not disturb is active, the process will determine if there is an end-time associated with the do not disturb notification 309. Although not shown, an additional determination may be made as to whether or not the event qualifies for passthrough. Passthrough of do not disturb events based on preselected criteria is described in greater detail in co-pending application Ser. No. ______, filed on August XX, 2011, the contents of which are incorporated herein by reference.

If there is not a selected end time associated with the do not disturb feature (e.g., the user has simply randomly enabled do not disturb, as opposed to a do not disturb period having been set), the system may wait a selected period of time 311 and then attempt to send the signal again. It is also possible, for example, that during this period of time a second event has occurred, so that multiple events will back up and queue for delivery once the do not disturb period is over.

If there is a particular end time associated with a do not disturb state, the system will wait at least until that time, and then attempt to send the notification(s) 313. Since the user may have re-enabled do not disturb at the expiration of the previous period, the system, in this embodiment, will again check to see if do not disturb is active before delivering the notifications.

FIG. 4 shows a second illustrative event queuing process. In this example, an application running on the phone acts as both the queuing mechanism and gatekeeper. Additionally or alternatively, a similar process could be running on a remote server, with the server acting as the queuing mechanism and gatekeeper. Or, a software module running on a VCS could serve the functionality shown in FIG. 4.

In this example, the process receives a notification of an event to be broadcast to a user 401. The process checks to see if the do not disturb feature is active 403, and, if not active, the process allows the notification to be delivered 407.

Also, in this example, a passthrough feature is enabled, such that if the event qualifies as an event that is to be passed through 405, the process allows the notification 407 to occur. Passthough, as previously noted, can be automatically enabled for certain critical events (e.g., theft) and/or selectively enabled based on user priorities.

If the event does not qualify for passthrough and if do not disturb is enabled, the process may then buffer the event 409 to be delivered at a later point in time when do not disturb is not active. The process may periodically determine if the do not disturb period has ended 411, and, if it has not, wait for some period of time 413 and then check again.

Once the period has ended, the process may notify a user of events that have been buffered which were blocked by the do not disturb feature 415.

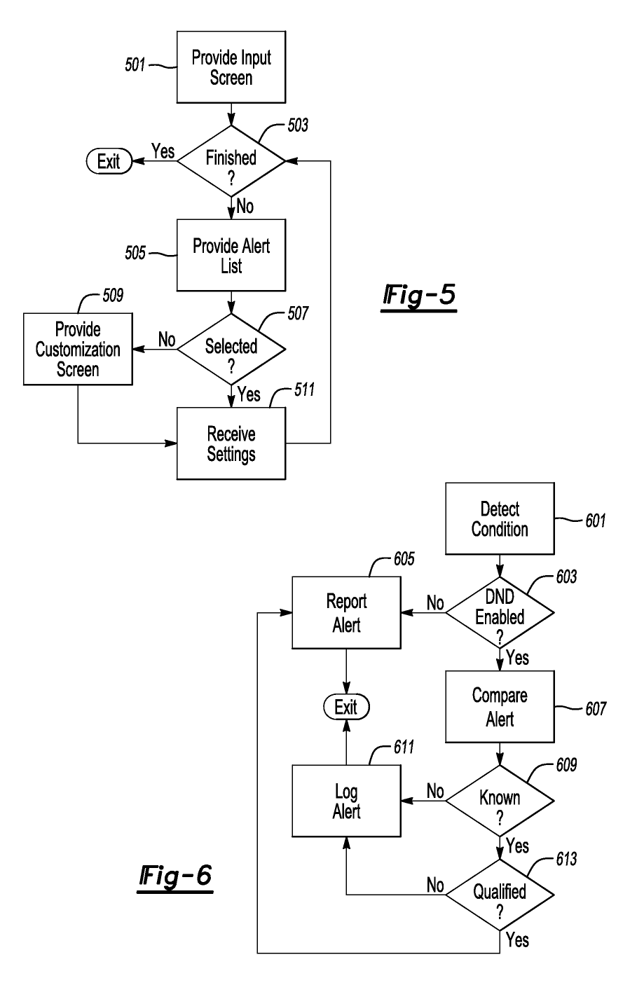

FIG. 5 shows an illustrative example of an alert customization process. In this illustrative example, a driver is capable of customizing the processing of one or more alerts. Varying alerts may be more or less relevant to a driver depending on additional factors. For example, without limitation, an alert relating to a vehicle charge state, such as, a minimum level of charge required to reach work may not be achieved, may be more relevant within a few hours of a driver's leaving for work, as opposed to at 6 PM.

Situations such as the above can occur at all hours. A power outage, for example, or a loose plug on an electric vehicle, can cause the vehicle to stop charging. On one hand, the driver may want to receive a more critical alert when a timing situation increases the criticality. On the other hand, a driver may not want to have their sleep interrupted for any but the most critical alerts.

In another example, a minimum charge may be achieved, but a full charge may not be achieved. Additionally, power may cost varying amounts at varying times of day. If a minimum charge is achieved and a more expensive power window has been reached, due to time of day, the vehicle may desire to alert the driver that charging can continue, but the cost will be greater. If the driver is not in a do not disturb mode, the driver may wish to receive this alert. But, if the driver does not wish to be disturbed, this alert may not be as critical and thus may be blocked and ignored or delivered at a later time.

Varying situational factors may also change the criticality of alerts. If a vehicle “knows” that a certain minimum charge is required for a driver to reach work, based on, for example, past driving behavior, the vehicle may generate an alert if charging is interrupted prior to reaching the minimum charge state. Of course, the vehicle may also “know” when a driver leaves for work. If the interruption occurs at 7 PM, if it would only require an hour of charging to complete the charging process, and the vehicle knows that the driver is not historically likely to use the vehicle until 7 AM, the alert may be given a lower priority setting (and thus not “pass through” a do not disturb state). If, however, time passes until 4 or 5 AM, and the vehicle has still not resumed charging, the alert priority may escalate to a pass through level.

In another version of the above example, the driver may invoke additional logic as follows. The driver may “preset” a time, such as, for example, 11 PM when the driver typically goes to sleep. Since the driver is more likely to be responsive to alerts received at 11 PM than at 4 AM, the system may consider some period of time prior to 11 PM as a time when certain alerts should be escalated. Instead of waiting until 4 AM to notify the driver that charging has been interrupted, the vehicle may escalate the alert proximate to 11 PM. This gives the driver ample time to ensure charging has resumed, without interrupting sleep. Alerts generated after 11 PM will be given due consideration according to preset logic. In this example, the driver may have a do not disturb mode enabled at 7 PM as before. When 10:30 PM or some other time reasonably proximate to the sleep time is reached, certain alerts may be escalated, causing pass through of the do not disturb state. Despite the fact that seven or eight hours of potential charge time remain, and only one hour of charge time is needed, this system will allow the driver to check on the vehicle before going to bed, as opposed to getting up in the middle of the night. If charging is re-interrupted later, the alert can be handled accordingly.

Various vehicle systems may generate alerts depending on changes in vehicle states. For example, cold weather could generate a lower tire pressure. Assuming the tire pressure only drops a PSI or two, it is probably not critical that a driver be woken at 4 AM to receive this notification. On the other hand, if some factor causes a tire to deflate to an unusable level (such as, for example, a slow leak), the driver may want to know about this early enough to have sufficient time to address the issue.

In the example shown in FIG. 5, the process provides an input screen 501. Input to the alert processing can be provided in a vehicle, online, on a phone app, etc. Settings elected outside the vehicle or on a system other than the vehicle computing system can be transferred to a vehicle computing system by appropriate means (wireless, wired, flash memory, etc.).

If there is no input, or input is finished 503, the process exits. Otherwise, a list of possible alerts is provided 505. In this embodiment the process provides a list of alerts that are preprogrammed to be detected by a vehicle manufacturer or software provider. If a particular alert is selected 507, the process may then present a screen allowing variables or conditional levels for the alert to be set 511. For example, the user may be able to set a base criticality of the alert, and may also be able to set conditions under which an alert can be escalated (or during which the base criticality may apply).

If no particular alert is selected, the user may be given the option to custom build an alert. Certain alerts may not be preconfigured to be detected and the user may be able to assemble one or more particular alerts. Or a base option, such as, but not limited to, “charge level” may be available, and then the user may custom set the corresponding charge level under which an alert status may occur 509. The user can then set the criticality and/or escalation variables.

FIG. 6 shows an illustrative example of an alert handling process. In this illustrative example, an alert-worthy condition is detected 601. This alert may correspond to an alert for which customization, criticality and or escalation settings have been enabled, or the alert may simply be a change in the state of a vehicle system or environmental condition that may affect the operability of the vehicle.

If do not disturb is not enabled 603, the alert may be reported to the user 605. The alert may not always be reported in all embodiments, but in this example it is assumed that all alerts are sent to the user if do not disturb is not enabled.

If do not disturb is enabled, the alert is compared to a list of alerts for which settings have been enabled 607. Certain alerts may also have settings pre-enabled by a vehicle manufacturer, if, for example, they are considered to be user critical. If the alert is a “known” alert 609, for which settings have been enabled, the process may check to see if the alert qualifies for pass through of the do not disturb mode.

If the alert is unknown, or does not qualify for pass through, the system may log the alert 611. Logged alerts may be delivered once do not disturb is disabled, or may be delivered if situational changes dictate escalation of the alert(s).

Do not disturb modes may be enabled in several fashions. In one non-limiting example, the do not disturb setting may be a phone-based setting. In such a case, the alert processing may be handled by the phone itself, with all alerts being sent to the phone, and then delivery being determined by an application running on the phone. In another example, a do not disturb mode may be determined by the settings associated with an alert. That is, certain alerts may have a setting designated when they are or are not to be delivered, thus creating a dynamic do not disturb enablement based on settings associated with the alert. Other suitable do not disturb paradigms are also considered to be within the scope of this invention.

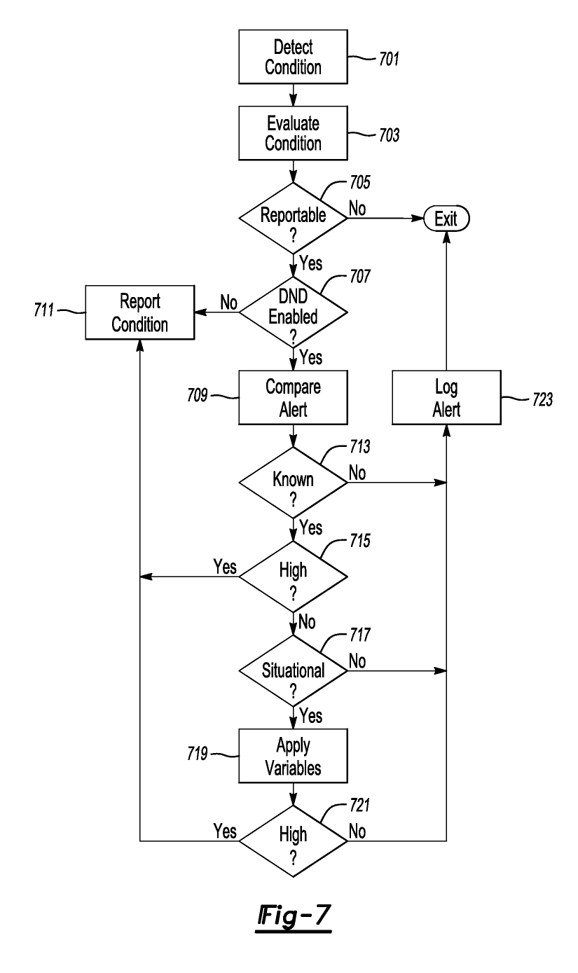

FIG. 7 shows another illustrative example of an alert handling process. In this example, a potential alert condition is detected by a vehicle system 701 and communicated to the handling process. The condition is evaluated by the process 703 to determine if it corresponds to a reportable condition 705. If the process has been instructed to ignore the particular condition, the process may exit.

Otherwise, the process determines if do not disturb is enabled 707. As noted, depending on where the do not disturb feature occurs, some steps of this process may be performed by an application running on a remote device. For example, step 701 may occur at the vehicle and then the condition may be relayed to a phone or other wireless device for evaluation 703. Or, steps 701 - 705 may be performed by a vehicle process and then the alert may be relayed to a phone or other wireless device for processing, assuming the condition is a reportable condition. Etc.

If do not disturb is disabled 707, the condition may be reported 711. If do not disturb is enabled, the condition may be compared to a list of alerts that have conditions associated therewith 709. If the alert is not a “known” alert 713, the alert may be logged for later delivery or processing 723.

If the alert is known, the process may check to see if an alert criticality is high (or has another pass through state associated therewith) 715. A highly critical alert may be reported 711. If the alert is not highly critical or has another pass through state associated therewith, the process may check to see if there are situational factors associated with the alert that may affect the criticality of the alert 717. If there are no situation factors associated with the alert, the alert may be logged for later processing 723. If situational factors exist (e.g., without limitation, time of day, level of charge, likelihood of correction of problem before predicted driving period, etc.), those factors may be applied to the alert 719 to determine if a criticality level of the alert is affected.

If application of the situation changes the criticality (or triggers a criticality) of the alert to a high, pass through, etc. state 721, the alert may be reported despite the enablement of a do not disturb condition. Otherwise, the alert may be logged for later processing 723 (or ignored).

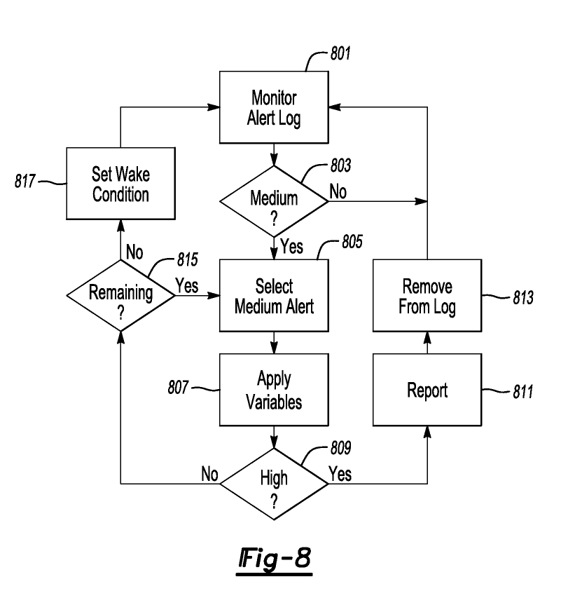

FIG. 8 shows an illustrative example of an alert log handling process. In this example, one or more alerts has been previously logged, those alerts not being in a proper state to pass through a do not disturb function. Because situations may change, as previously noted, and because criticality of alerts may change, it may be reasonable to recheck previously logged alerts to determine if alert states change to a point where the alerts should be delivered.

In this example, the process monitors the alert log 801 or other alert repository. In this example, alerts are classified as “low,” “medium,” or “high,” although any classification system may be used. “Low” classified alerts are alerts that cannot be escalated to higher alert levels, and will only be delivered once a do not disturb status is revoked (if they are delivered at all).

“Medium” level alerts are alerts that may, based on situational changes, escalate to “high” alerts and qualify for alert pass through of a do not disturb setting. Accordingly, in this example, the process checks to see if any “medium” level alerts are logged (i.e., alerts that may escalate to “high” alerts) 803. If no “medium” alerts are present, the process continues to monitor the alert log.

If one or more “medium” alerts are present, the process selects a first medium alert 805 and checks the situational variable(s) associated with the alert 807 to see if the alert should be escalated to a “high” status 809. If the alert is not escalated based on any changes (or lack thereof) in the situational conditions associated with the alert, the process may check to see if any additional “medium” alerts remain 815 and continue processing the alerts.

If no “medium” alerts remain, the process may set one or more conditions under which a next monitoring check should be run 817. For example, without limitation, the process may always check the alert log every predetermined unit of time. If, however, that time period is once an hour, and if a particular alert may escalate to critical in fifteen minutes from a current check, the process may set a condition where the next check of the log occurs in fifteen minutes. Other suitable check conditions may also be set, depending on a next scheduled check time and current situational variables associated with one or more “medium” level alerts.

If the alert is escalated to a “high” status, the process may pass through the do not disturb function and report the condition 811. Once the alert has been reported, it may be removed from the log 813 so that it does not accidentally trigger future reporting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A computer-implemented method comprising:
detecting a reportable change in vehicle state;
qualifying, via a vehicle-associated computing system, the reportable change for delivery based on evaluation of one or more situational variables associated with the reportable change; and
conditional on the qualification of the reportable change as deliverable, delivering a notification regarding the reportable change to a wireless device, to be delivered to a device user despite an active wireless device do not disturb state.

2. The method of claim 1, wherein the reportable change is determined at least in part by a preset condition corresponding to the change.

3. The method of claim 1, wherein the reportable change is determined at least in part by a driver input setting corresponding to the change.

4. The method of claim 1, wherein the delivering a notification includes sending a text message.

5. The method of claim 1, wherein the delivering a notification includes sending an email.

6. The method of claim 1, wherein the delivering a notification includes playing a pre-recorded message to a dialed phone number.

7. The method of claim 1, wherein the situational variables include a time of day.

8. The method of claim 1, wherein the situational variables include a day of week.

9. The method of claim 1, wherein the situational variables include a level of charge.

10. The method of claim 1, wherein the situational variables include an effect on the drivability of a vehicle.

11. The method of claim 1, further comprising, conditional on the qualification of the reportable change as non-deliverable, logging the reportable change for later delivery.

12. A computer readable storage medium storing instructions that, when executed, cause a processor of a computing system to execute the method comprising:
detecting a reportable change in vehicle state;
evaluating one or more situational variables associated with the reportable change to determine a criticality level of the reportable change;
comparing the criticality level of the reportable change to a filter associated with an active do not disturb state to qualify the reportable change for delivery; and
conditional on the qualification of the reportable change as deliverable, delivering a notification relating to the reportable change despite the active do not disturb state.

13. The computer readable storage medium of claim 12, wherein the reportable change is determined at least in part by a preset condition corresponding to the change.

14. The computer readable storage medium of claim 12, wherein the reportable change is determined at least in part by a driver input setting corresponding to the change.

15. The computer readable storage medium of claim 12, wherein the delivering a notification includes sending a text message.

16. The computer readable storage medium of claim 12, wherein the delivering a notification includes sending an email.

17. The computer readable storage medium of claim 12, wherein the delivering a notification includes playing a pre-recorded message to a dialed phone number.

18. A computer implemented method comprising:
monitoring, via a vehicle-associated computing system, a log of alerts having been logged due to non-delivery to a user resulting at least in part from a do not disturb state of a wireless device;
selecting at least one logged alert having one or more situational variables associated therewith for evaluation;
evaluating the one or more situational variables to determine if a change in a deliverable nature of the logged alert has occurred; and
contingent on a change in the deliverable nature of the logged alert to a deliverable status, delivering a notification to a wireless device relating to the logged alert, for delivery to a device user despite an active do not disturb state of the wireless device.

19. The method of claim 18, further including removing the logged alert from the log of alerts following delivering the notification.
